(19) United States
(12) Patent Application Publication
(10) Pub. No.: US 2026/0281879 A1
(43) Pub. Date: Sep. 17, 2026

(54) ACCESS POINT CONNECTION MIRRORING

(71) Applicant: Cypress Semiconductor Corporation, San Jose, CA (US)

(72) Inventors: Vikram Kumar Ramanna, San Jose, CA (US); Kameswara Medapalli, Saratoga, CA (US); Roman Baker, Las Vegas, NV (US); Brian Bedrosian, San Carlos, CA (US)

(73) Assignee: Cypress Semiconductor Corporation, San Jose, CA (US)

(21) Appl. No.: 19/343,997

(22) Filed: Sep. 29, 2025

Related U.S. Application Data
(60) Provisional application No. 63/770,895, filed on Mar. 12, 2025.
(60) Provisional application No. 63/805,842, filed on May 14, 2025.

(51) Int. Cl. H04W 48/16

(52) U.S. Cl. CPC H04W 48/16

(57) ABSTRACT

A method of operating a first station in a basic service set (BSS) including establishing a first wireless link with an access point (AP), determining that one or more metrics corresponding to the first wireless link satisfy respective thresholds, and transmitting, to a second station in the BSS, a request that the second station forward network traffic transmitted by the first station toward the AP over a second wireless link between the second station and the AP.

### CROSS-REFERENCE TO RELATED APPLICATIONS

This application claims priority to U.S. Provisional Patent Application No. 63/770,895, filed Mar. 12, 2025, and U.S. Provisional Patent Application No. 63/805,842, filed May 14, 2025, the disclosure of which is incorporated by reference in their entirety.

### BACKGROUND

A Basic Service Set (BSS) is the fundamental building block of an IEEE 802.11 (Wi-Fi) network. A BSS can include an access point (AP) and one or more stations (STAs) that communicate through the AP. The AP can serve as a central coordinator of the BSS and provide STAs connectivity to a wired network or the internet. STAs may be client devices, such as laptops, smartphones, or other Internet of Things (IoT) devices that connect to the AP over wireless links.

### BRIEF DESCRIPTION OF THE FIGURES

To easily identify the discussion of any particular element or act, the most significant digit or digits in a reference number refer to the figure number in which that element is first introduced.

FIG. 1 illustrates a system that includes an access point (AP), a first station (STA), and a second station that participates in a common basic service set (BSS), according to one embodiment.

FIG. 2 illustrates a system in which a helper station concurrently acts as a repeater with respect to multiple neighboring stations within the same basic service set (BSS), according to one embodiment.

FIG. 3 illustrates a system that supports multi-hop forwarding within a basic service set (BSS), according to one embodiment.

FIG. 4 illustrates a method of establishing a repeater relationship with another station in a same BSS after determining that a wireless link has entered a degraded state or condition, according to one embodiment

FIG. 5 illustrates a method of establishing a repeater relationship with another station in a same BSS after receiving a request, according to one embodiment.

FIG. 6 illustrates a method of two stations establishing a repeater relationship after determining that a wireless link has entered a degraded state or condition, according to one embodiment.

### DETAILED DESCRIPTION

In wireless local area networks (WLANs), stations (STAs) can rely on a stable wireless link to an access point (AP) for connectivity. However, this wireless link can degrade significantly under certain conditions, leading to poor performance or complete connection loss. One common factor is distance: as a station moves farther from the AP, there is an increased likelihood of retransmissions, higher latency, and jitter, which can affect received signal strength indicator (RSSI), reduce data transfer rates, and increase the likelihood of packet errors or complete connection failure. This can be particularly problematic for real-time or latency-sensitive applications such as video streaming, camera feeds, or the like.

Environmental factors can also affect the stability of a wireless link. Physical obstructions such as walls, doors, and furniture attenuate radio signals, while building materials like concrete or metal can severely limit wireless signal propagation. In residential and commercial environments, interference from other devices such as microwave ovens, phones, neighboring Wi-Fi networks, or the like can introduce additional noise, which reduces the effective signal-to-noise ratio (SNR) of the wireless link. These conditions can cause frequent retransmissions and unstable throughput, making the user experience unpredictable and undesirable.

Aspects and embodiments of the present disclosure address these challenges and others by providing techniques that enable a station experiencing degraded connectivity to an AP to dynamically leverage another station within the same basic service set (BSS) as a repeater. As used herein, unless otherwise stated, a station operating “as a repeater,” or “in repeater mode,” refers to a station that maintains its own wireless link to an AP while (a) forwarding network traffic received from another station toward the AP, and/or (b) forwarding traffic from the AP toward that other station. For example, upon a first station determining that one or more link-quality metrics associated with its wireless connection to an AP fall below respective thresholds, the first station can initiate a request to a second station in the BSS to forward network traffic transmitted by the first station toward the AP. This approach can allow the first station to maintain connectivity without requiring additional infrastructure such as dedicated repeaters, range extenders, or wired backhaul.

In some embodiments, the first station evaluates metrics such as received signal strength indicator (RSSI), signal-to-noise ratio (SNR), packet error rate (PER), retry count, or throughput to determine whether its wireless link to the AP is insufficient for reliable communication. Upon detecting a degraded condition of this wireless link, the first station may request one or more nearby stations in the BSS (including the second station) to forward network traffic transmitted by the first station toward the AP (sometimes referred to herein as a forwarding request). This forwarding request may include control signaling transmitted to the neighboring stations in-band over the WLAN or out-of-band using an auxiliary channel such as Bluetooth Low Energy (BLE). While conventional infrastructure BSS configurations do not permit direct station-to-station (STA-to-STA) communication that bypasses the AP, embodiments described herein may enable such communication through alternative wireless links. For example, two stations within the same BSS may establish a direct link using protocols such as softAP/STA, Neighbor Awareness Networking (NaN), Wi-Fi Peer-to-Peer (P2P), or similar mechanisms. These approaches may allow stations to negotiate and maintain a forwarding relationship independently of the AP, thereby facilitating repeater functionality even in scenarios where STA-to-AP communication has been completely lost.

The second station, upon receiving the forwarding request, can determine whether it has sufficient capacity to act as a repeater. Here, the second station may consider its own traffic demands and/or an expected additional load from the first station. If the second station has sufficient capacity, the second station may begin forwarding traffic received from the first station toward the AP while continuing to transmit its own traffic. The second station may maintain a virtual access point (VAP) interface to handle traffic received from the first station and may apply bridging or network address translation (NAT) techniques for packet forwarding. In some embodiments, the second station may implement quality-of-service (QoS) scheduling to manage these concurrent flows of traffic.

In some cases, before forwarding traffic received from the first station, the second station may report various link quality metrics or current traffic demands to the first station. The first station may gather this information from multiple candidate stations, and may select the second station based on an optimization algorithm that considers factors such as link quality, current traffic load, or the like. In at least one embodiment, the first station may select the second station of the multiple candidate stations based on timeliness. For example, the first station may select the second station based on the second station being the first to acknowledge or accept the forwarding request from the first station.

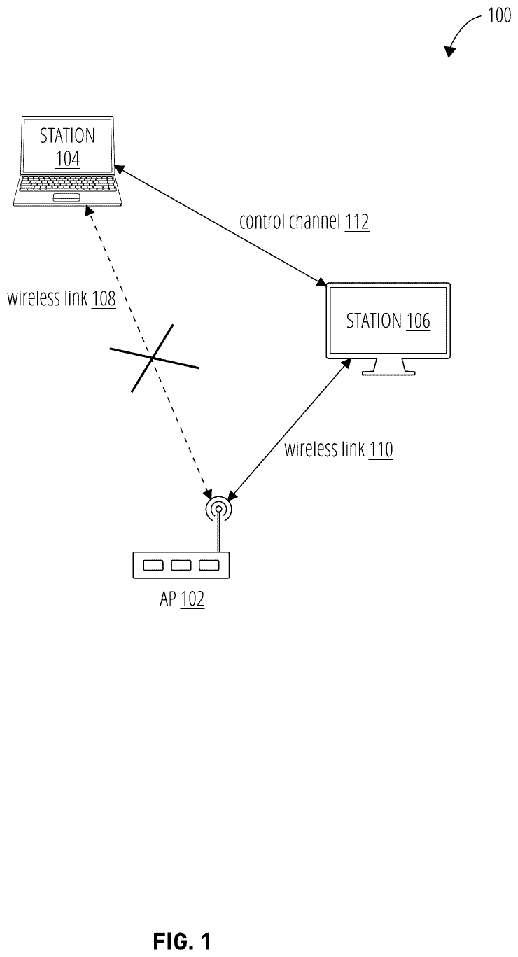

FIG. 1 may illustrate a system 100 that can include an access point (AP) 102, a first station (STA) 104, and a second station (STA) 106 that may participate in a common basic service set (BSS), according to one embodiment. In the example of FIG. 1, a wireless link 108 may couple station 104 to AP 102, and a wireless link 110 may couple station 106 to AP 102. A control channel 112 may provide a signaling path between stations 104 and 106 for discovery, negotiation, configuration, monitoring, and teardown of a helper-oriented forwarding relationship. The control channel 112 may be realized over the same WLAN (in-band) or over an auxiliary out-of-band (OOB) radio, as further described below.

Stations 104 and 106 may be any client devices capable of wirelessly communicating with other electronic devices within a network. Stations 104 and 106 and may include, by way of example, IP cameras, security sensors, smart speakers, home automation hubs, set-top boxes, laptops, tablets, smartphones, or any other Internet-of-Things (IoT) device. AP 102 may be any WLAN (e.g., Wi-Fi) access point or gateway operating in infrastructure mode. In some deployments, the station 104 may correspond to a range-constrained device located closer to the edge of coverage of the AP 102, whereas station 106 may correspond to a device positioned closer to AP 102 or otherwise experiencing more favorable channel conditions. All devices may participate in the same basic service set (BSS) and may be logically coordinated by the AP 102.

Station 104 may monitor link-quality and performance information for its wireless link 108 to AP 102 and may determine that the wireless link 108 is in a degraded condition when one or more metrics satisfy associated thresholds. The monitored metrics may include one or more of received signal strength indicator (RSSI), signal-to-noise ratio (SNR), packet error rate (PER), retry count, measured throughput, or latency. The metric thresholds may be fixed, adaptive, or policy-driven. Upon detecting a degraded condition of the wireless link 108, the station 104 may seek assistance from neighbor stations, such as station 106, that are members of the BSS and may be able to forward traffic toward AP 102 on behalf of station 104.

In seeking assistance, the station 104 may transmit a forwarding request to one or more neighbor stations, including station 106. The forwarding request may be communicated using either in-band signaling with respect to the BSS or via an out-of-band (OOB) channel, depending on the capabilities and current connectivity of the stations 104 and 106.

In embodiments where the forwarding request is communicated using in-band signaling, the forwarding request may be transmitted in-band over the WLAN. For example, station 104 may generate a management or action frame, such as a public or vendor-specific action frame, addressed to station 106 and relayed by AP 102 within the BSS. In other embodiments, the forwarding request may be encapsulated in an IP-level unicast or multicast message, such as a UDP packet, that is delivered to station 106 via AP 102. In at least one embodiment, station 104 may also employ tunneled direct link setup (TDLS) signaling to establish a direct control path to station 106. The choice of in-band signaling mechanism may depend on the network configuration, capabilities of the AP 102, capabilities of the station 104 or station 106, policy preferences, or the like.

In addition to scenarios involving degraded (but usable) wireless links, station 104 may also be capable of communicating directly with station 106 in the event that station 104 experiences a complete loss of connectivity to AP 102. In such cases, station 104 may establish a direct link to station 106 using a variety of protocols and mechanisms designed to facilitate peer-to-peer communication outside the conventional infrastructure BSS framework. For example, protocols such as SoftAP/STA mode may allow station 106 to instantiate a temporary access point interface, enabling station 104 to associate and transmit traffic for forwarding. Neighbor Awareness Networking (NaN) may provide proximity-based device discovery and communication, supporting dynamic formation of forwarding relationships. Wi-Fi Peer-to-Peer (P2P) may enable station 104 and 106 to negotiate and maintain a direct connection independent of the AP 102. Tunneled Direct Link Setup (TDLS) may allow stations 104 and 106 within the same BSS to establish direct links for both control and data traffic, bypassing the AP 102. These protocols, among other similar protocols which may also be utilized, may allow station 104 and station 106 to negotiate and maintain a forwarding relationship for AP 102 even in scenarios where STA-to-AP communication has been completely lost between station 104 and AP 102.

In embodiments where the forwarding request is communicated using OOB signaling, the forwarding request may be transmitted out-of-band using an auxiliary wireless technology, such as Bluetooth® Low Energy (BLE). For example, station 104 and station 106 may each include BLE radios and may be configured to advertise and scan for BLE services that facilitate device discovery and control signaling. Upon detecting a degraded condition of the WLAN link, the station 104 may initiate a BLE connection to station 106 and transmit the forwarding request over that BLE connection. In at least one embodiment, the station 104 may transmit the forwarding request as a BLE generic attribute profile (GATT) or a similarly structured BLE frame. The OOB approach may allow the station 104 to communicate the forwarding request to the station 106 even if the station 104 has completely lost connectivity to the AP 102.

The forwarding request may include a variety of information to facilitate decision-making and session setup at station 106. The request may include identification information for station 104 (such as MAC address, device type, or capabilities), a characterization of the traffic to be forwarded (e.g., estimated data rate, burst profile, or quality-of-service (QoS) class), a snapshot of current link-quality metrics for the wireless link 108 (such as RSSI, SNR, PER, retry count, throughput, or latency), an expected forwarding traffic rate for network traffic originating or passing through the station 104, or the like. The request may further specify a requested session lifetime or lease duration, termination conditions, and any policy constraints or preferences, such as preferred data-plane modes (e.g., virtual AP (VAP) association, bridging, network address translation (NAT), wireless distribution system (WDS), or tunneled direct link setup (TDLS)). In some embodiments, the forwarding request may also solicit a measurement report from neighboring stations in the BSS regarding the quality and utilization of their own respective wireless links with the AP 102. For example, the forwarding request may solicit a measurement report from the station 106 with respect to its wireless link 110 to AP 102. These measurement reports may assist station 104 in selecting an optimal (or at least suitable) station of all candidate stations in the BSS.

In embodiments where the station 104 selects the station 106 to forward network traffic from the station 104 to the AP 102 (or where station 106 is to forward network traffic from station 104 with or without a selection by station 104), station 106 may instantiate a virtual access point (VAP) interface. The VAP interface may be configured to advertise a service set identifier (SSID) that may be the same as, or different from, the SSID of the BSS coordinated by AP 102. The VAP may operate on the same or a different channel as the primary BSS, and may be configured to accept association requests from one or more stations, including station 104. In various embodiments, the helper station (station 106) does not enumerate as the infrastructure AP (AP 102), but rather instantiates a temporary, session-specific virtual AP interface solely for the purpose of relaying traffic for the requesting station (station 104). In other words, in at least one embodiment, this VAP does not serve as a general-purpose access point for the BSS.

Upon instantiation of the VAP, the station 106 may transmit a notification or beacon advertising the availability of the VAP for association. The station 104, upon receiving such a notification or upon being otherwise informed of the VAP's presence (e.g., via the forwarding request/acceptance exchange), may initiate an association procedure with the VAP. This association procedure may follow any suitable association protocol, such as those found in IEEE 802.11.

Once the association between station 104 and the VAP at station 106 is established, station 104 may transmit network traffic destined for AP 102 to the VAP interface at station 106. Station 106 may then forward the received traffic toward AP 102 over its own wireless link 110, using bridging, network address translation (NAT), or other forwarding techniques as appropriate. In some embodiments, station 106 may maintain per-originator forwarding tables, perform address resolution protocol (ARP), and manage dynamic host configuration protocol (DHCP) relay or assignment for the associated station 104. According to embodiments, station 106 may preserve the originator's identity (here, station 104), enabling AP 102 to attribute uplink traffic to the originator and for the helper (here, station 106) to re-deliver downlink frames to the originator. In various embodiments, station 106 may be configured to preserve quality-of-service (QoS) markings, enforce policy constraints, and support concurrent forwarding of network traffic from station 104 and other stations in the BSS.

The VAP-based association may be maintained for the duration of the forwarding session, as determined by session lifetime parameters, teardown messages, detection of improved link conditions for station 104, or the like. Upon termination of the forwarding session, station 104 may disassociate from the VAP and resume direct communication with the AP 102, or may initiate association with a different helper station (not illustrated). The VAP interface at station 106 may be deactivated when no longer needed, or may remain available for future association requests from other stations experiencing degraded connectivity to the AP 102.

While the above-described embodiments of the present disclosure utilize a VAP, other suitable protocols or processes that can allow the station 104 to communicate directly with the station 106 may be used. For example, protocols such as Tunneled Direct Link Setup (TDLS), Wi-Fi Peer-to-Peer (P2P), Neighbor Awareness Networking (NaN), or AP/STA configurations may be employed to establish a data path or wireless link between the station 104 and the station 106.

In some embodiments of the present disclosure, network address translation (NAT) may be employed by the helper station (station 106) to facilitate forwarding of network traffic between an originator station (station 104) and the access point (AP 102). When NAT is utilized, station 106 may instantiate a routed subnet for associated originator stations, such as station 104, and assign local IP addresses via DHCP or static configuration. As station 104 transmits network traffic intended for AP 102, station 106 may translate the source IP address of each packet to its own IP address before forwarding the packet over its wireless link (link 110) to AP 102. This approach allows multiple originator stations to share the helper's wireless link to the AP.

According to embodiments, the forwarding request may be transmitted from station 104 to station 106 over a control channel 112. In some embodiments, the forwarding request may be conveyed out-of-band (OOB), such as via Bluetooth® Low Energy (BLE). In at least one embodiment, the forwarding request may be transmitted in-band via AP 102. For example, station 104 may transmit the forwarding request to AP 102, which may then transmit the forwarding request to station 106. Acknowledgment or acceptance messages sent from station 106 to station 104 may also be communicated via AP 102. In some embodiments, the forwarding request may be carried in-band over the WLAN using public or vendor-specific action/management frames relayed by AP 102, Internet Protocol (IP) messages tunneled through the AP, or tunneled direct-link signaling (e.g., TDLS) where permitted.

Station 104 may originate a forwarding request addressed to station 106 over control channel 112. The forwarding request may convey various information, such as identification and capability information for station 104, a characterization of the traffic to be forwarded (e.g., estimated rate, burst profile, QoS class, or the like), current values for link-quality metrics corresponding to wireless link 108, an indication of a requested session lifetime and termination conditions, or the like. In some cases, the forwarding request may solicit a measurement report from station 106 concerning the quality and utilization of its own respective wireless link to AP 102, which here is illustrated as wireless link 110.

Upon receiving the forwarding request, station 106 may authenticate and validate the forwarding request and may determine whether sufficient forwarding capacity is available to handle forwarding network traffic from station 104 to the station 106. To determine whether sufficient forwarding capacity exists, station 106 may consider certain factors or metrics, such as current utilization of link 110 to AP 102, observed or predicted PHY rates, queue depth, airtime availability, existing QoS commitments, the expected forwarding load for station 104 as indicated in the request, or the like. Station 106 may respond to the forwarding request with an acceptance message when the station 106 has sufficient forwarding capacity. An acceptance message may include various data such as a granted session lifetime, a selected data-plane mode, QoS parameters or weights, identifiers for correlating subsequent configuration and teardown messages, a report of link-quality metrics corresponding to the wireless link 110, or the like. In at least some embodiments, station 106 may respond to the forwarding request with a negative acknowledgment when the station 106 does not have sufficient forwarding capacity.

Upon acceptance, station 106 may enter a repeater mode while maintaining its own association to AP 102 over link 110. While operating in repeater mode, station 106 may schedule its own traffic (e.g., traffic originating at the station 106) and forwarded traffic (e.g., traffic originating at the station 104) according to one or more QoS policies. The policies may include prioritization algorithms, airtime fairness, rate limiting, latency/jitter targets, or the like. Station 106 may optionally coordinate predictable transmission opportunities using features such as Target Wake Time (TWT) or service-period scheduling, and such coordinated activity may present detectable periodic management information on the channel.

In at least some embodiments, the system 100 may employ stateless relay that allows opportunistic forwarding of network traffic originating from station 104 without prior acceptance. Here, the station 104 may transmit the forwarding request and begin transmitting network traffic before receiving acceptance from the station 106.

In deployments with multiple candidate helpers, station 104 may transmit forwarding requests to a set of neighboring candidate stations, and may collect responses that include capability indications and link-quality reports corresponding to each of the set of neighboring candidate stations. In at least one embodiment, the station 104 may select a helper such as station 106 based on an optimization algorithm that can consider one or more of link quality or current load. In some embodiments, station 104 may periodically re-evaluate the selection and may migrate the session to another candidate station if performance degrades or if a better candidate becomes available. In one embodiment, the station 104 may employ a selection policy that selects between the set of neighboring candidate stations based on which candidate station responds to the forwarding request with an acceptance message first.

In certain embodiments, the station 106 may proactively advertise repeater availability and current forwarding capacity over the control channel 112 (e.g., via vendor-specific information elements in beacons or probe responses, TDLS discovery attributes, or BLE advertisements). Such announcements can include capability flags and coarse capacity indicators, enabling faster selection and reduced negotiation latency when a station detects degraded connectivity. According to embodiments, station 104 may select station 106 to forward its network traffic to AP 102 based on a most recent advertisement made by station 106 about its own current forwarding capacity. After receiving such an advertisement and determining that the wireless link 108 is in a deteriorated condition, station 104 may evaluate the advertised capability flags and capacity indicators and then address its forwarding request to station 106. In some embodiments, station 104 may address its forwarding request to all stations in the BSS with sufficient forwarding capacity at the time that wireless link 108 enters a degraded condition.

In various embodiments, teardown of the forwarding session may occur upon expiration of the granted lifetime, upon an explicit terminate message from either station 104 or 106, upon detection of a failure condition (e.g., loss of VAP association, health-probe failure, or degradation of link 110 below thresholds), or upon improved connectivity of wireless link 108. Following teardown, station 104 may revert to direct communication with AP 102 over link 108 when available, or may initiate a new candidate station discovery and selection process to identify another helper station and re-establish the forwarding of network traffic from station 104 to AP 102.

The functionality described herein for stations 104 and 106 may be realized in firmware, device drivers, control software executing on processing devices of respective stations 104 and 106, or any combination thereof. The functionality described herein for stations 104 and 106 may utilize information maintained by a WLAN stack concerning association state, QoS configuration, observed link metrics, or the like. The functionality described herein for stations 104 and 106 may allow the system 100 to maintain network connectivity between station 104 and AP 102 in challenging radio conditions without additional fixed infrastructure (e.g., without additional repeaters or APs).

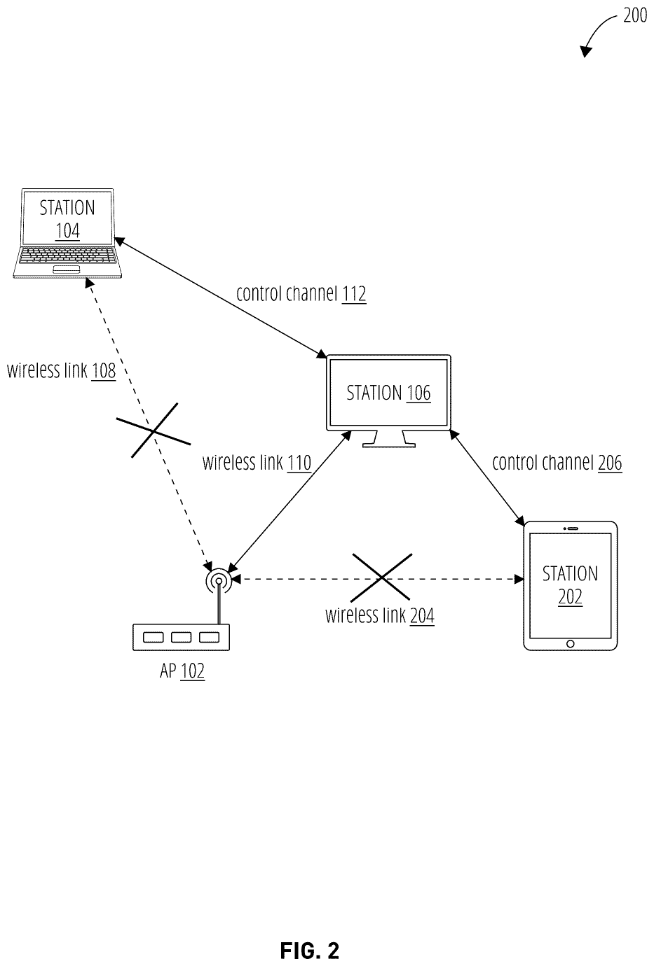

FIG. 2 illustrates a system 200 in which a helper station (here, station 106) concurrently acts as a repeater with respect to multiple originator stations within the same basic service set (BSS), according to one embodiment. Devices part of the system 200 (e.g., stations, APs) may include one or more features described with respect to the system 100 of FIG. 1. As in FIG. 1, AP 102 may coordinate the BSS, and station 104 may correspond to a range-constrained device whose direct wireless link (link 108) to AP 102 is in a degraded condition. In addition, station 202 may represent another station device (e.g., an IP camera, sensor, smart speaker, set-top box, laptop, tablet, smartphone, or other IoT devices) that participates in the same BSS and that may likewise experience degraded connectivity on a wireless link to AP 102, illustrated as link 210. Station 106 may maintain its own wireless link to AP 102, illustrated as link 110, and may provide forwarding service for traffic originating from multiple other stations in the BSS, including stations 104 and 202.

In some embodiments, station 104 and station 202 may each originate respective forwarding requests addressed to station 106 upon detecting degraded link conditions with AP 102. Discovery, negotiation, configuration, monitoring, and teardown associated with these forwarding relationships may be conducted over respective control channels between the originators and the helper. By way of example, a control channel 112 may couple stations 104 and 106, and a control channel 206 may couple stations 202 and 106. As described above with respect to FIG. 1, each control channel may be realized in-band over the WLAN (e.g., via public or vendor-specific action/management frames relayed by AP 102 or via TDLS) or out-of-band (OOB) over an auxiliary radio (e.g., BLE). The control signaling may convey identification and capability information, traffic characterizations (e.g., estimated data rate, burstiness, and/or QoS class), snapshots of current link-quality metrics (e.g., RSSI, SNR, packet error rate, retry count, measured throughput, or latency), requested session lifetimes and termination conditions, or the like.

Upon receipt of a forwarding request on either control channel 112 or 206, station 106 may authenticate and validate the request and may determine whether sufficient forwarding capacity is available to support an additional stream of network traffic. To this end, station 106 may evaluate one or more factors, such as current utilization of wireless link 110, observed or predicted PHY rates, queue depth, available airtime, existing QoS commitments, and the expected forwarding load communicated by the requesting station. In at least some embodiments, station 106 may maintain admission-control policies that govern concurrent forwarding sessions, including minimum and maximum resource allocations per network stream (or per originating station), overall session limits, and rules to ensure that station 106's own traffic (originating at station 106) is not starved. When sufficient capacity exists, station 106 may transmit an acceptance message (e.g., indicating a granted session lifetime, selected data-plane mode, and applicable QoS parameters) to the requesting station. Otherwise, station 106 may transmit a negative acknowledgment indicating that forwarding cannot be provided at that time. In other embodiments, no acknowledgment message may be transmitted back to the requesting station.

As illustrated in FIG. 2, station 106 can act as a repeater for any number of other stations in the BSS (subject to its capacity and policy constraints), including stations 104 and 202 concurrently. In some embodiments, station 106 may instantiate and maintain multiple concurrent forwarding sessions. For example, station 106 may maintain a first forwarding session corresponding to network traffic received from station 104 and a second forwarding session corresponding to network traffic received from station 202. Where a VAP-based association is used, station 106 may (i) instantiate a single VAP interface that accepts associations from multiple stations (including stations 104 and 202), or (ii) instantiate multiple VAP interfaces (e.g., distinct SSIDs or BSSIDs) to isolate and manage streams of network traffic. In some embodiments, station 106 may employ one or more of bridging or wireless distributed system (WDS) techniques to preserve originator identity without enumerating as the infrastructure AP 102.

While operating as a repeater with respect to station 104 and station 202, station 106 may schedule and forward uplink network traffic originating at station 104 and station 202 (or at least passing through station 104 and station 202 toward AP 102 over link 110), while also handling its own local traffic. Similarly, for downlink traffic, station 106 may receive frames destined for station 106, station 202, or another downlink station that is using station 106 or station 202 to forward its own network traffic to AP 102. Station 106 may re-deliver such frames over the chosen data path to the corresponding station (here, station 106 or station 202). In at least some embodiments, station 106 may maintain a per-originator state, which may include forwarding tables, address-resolution context (e.g., ARP), DHCP relay or assignment information (where applicable), mapping tables used to attribute uplink traffic to the correct originator and to filter/re-deliver downlink frames to the intended station, or the like. Station 106 may apply quality-of-service (QoS) policies (e.g., per-flow or per-access-category prioritization, airtime fairness, latency/jitter targets, and/or rate limiting) across all active sessions so as to bound the impact of forwarding on both the helper's own traffic and other originators'traffic. In some cases, the helper and originators may coordinate predictable transmission opportunities (e.g., using Target Wake Time (TWT) or service-period scheduling), which may present periodic management information on the channel indicative of the forwarding arrangement.

In at least one embodiment, station 202 may use the same or a similar forwarding request as station 104, including in-band and/or OOB signaling options and similar request contents. In multi-candidate deployments, station 202 may discover multiple potential neighboring stations and may select station 106 based on one or more factors, such as link-quality metrics, current load/capacity reports, or timeliness (e.g., first helper to acknowledge acceptance). Likewise, station 104 may re-evaluate its helper selection while station 202 is also being served, and either station 104 or station 202 may migrate an active session to a different neighbor station if performance degrades or a more suitable helper becomes available. In certain embodiments, stations 104 and 202 may employ a stateless relay option: upon issuing a forwarding request, they may begin transmitting traffic that a listening helper can opportunistically forward. In some embodiments, this stateless mode may be used transiently until a formal acceptance is received, after which QoS and admission controls may apply. However, in other embodiments, this stateless mode may be used indefinitely until station 104 or station 202 indicates to station 106 that its own wireless link to AP 102 (here, wireless link 108 or wireless link 204) is no longer in a degraded state and that the forwarding of its own network traffic is no longer needed.

Teardown of a forwarding session for station 104 and/or station 202 may occur upon expiration of a granted lifetime, upon receipt of an explicit terminate message from the originator or the helper, upon detection of a failure condition (e.g., loss of VAP association, health-probe failure, or degradation of link 110 below thresholds), upon improvement of the originator's direct link (e.g., wireless link 108 or wireless link 204) to AP 102, or the like. Following teardown, the affected stations 106, 202 may resume direct communication with AP 102 when feasible or may initiate a new discovery and selection process to identify an alternate neighboring station to act as a repeater.

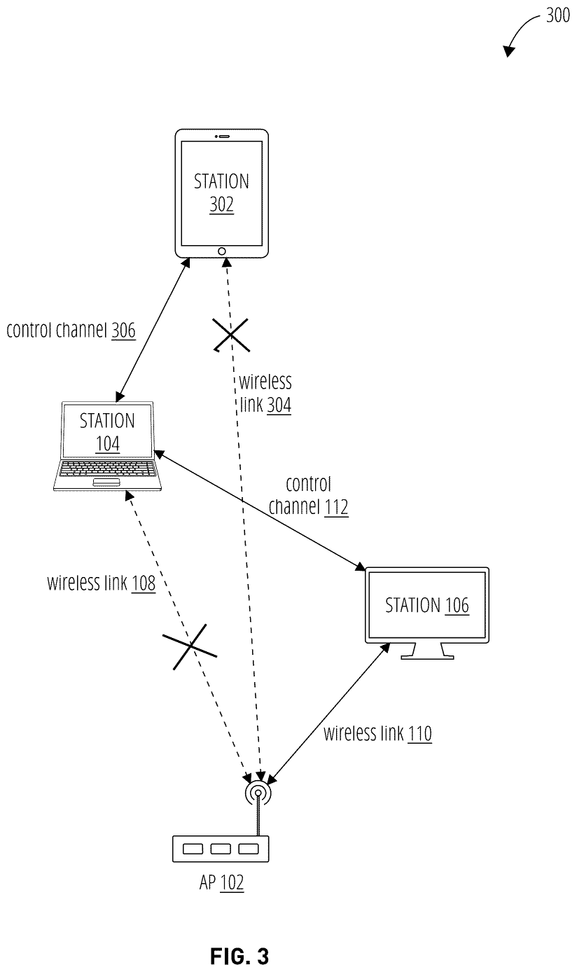

FIG. 3 may illustrate a system 300 that supports multi-hop (daisy-chain) forwarding within a basic service set (BSS), according to one embodiment. Devices that are part of the system 300 (e.g., stations, APs) may include one or more features described with respect to the system 100 of FIG. 1 or the system 200 of FIG. 2. As in FIG. 1, AP 102 may coordinate the BSS. As illustrated in FIG. 3, station 302 may correspond to a station located such that its direct wireless link to AP 102 is in a degraded condition, and signals transmitted by station 302 are too attenuated by the time they reach station 106 for station 106 to act as a direct repeater for station 302. However, station 104 may receive transmissions from station 302 with sufficient strength to act as a direct repeater for station 302. According to embodiments, the repeater relationship between station 104 and station 106 may already be established at the time station 302 transmits a forwarding request to stations within the BSS, or it may be initiated subsequently as needed. In either case, station 104 can act as an intermediate repeater for station 302, and station 106 can serve as an upstream repeater, enabling multi-hop forwarding from station 302 through station 104 and station 106 to AP 102.

In some embodiments, station 302 may originate a forwarding request to station 104 upon detecting that its link to AP 102 does not satisfy one or more thresholds for reliable communication. Discovery, negotiation, configuration, monitoring, and teardown for this downstream helper relationship may be conducted over a control channel 306 between station 302 and station 104. As described with respect to FIG. 1 and FIG. 2, the control channel 306 may be realized in-band over the WLAN (e.g., public or vendor-specific action/management frames relayed by AP 102 or TDLS) or out-of-band (OOB) over an auxiliary radio such as BLE. The forwarding request may convey identification and capability information for station 302, traffic characterization (e.g., estimated rate, burst profile, and/or QoS class), current values for link-quality metrics observed by station 302 (e.g., RSSI, SNR, packet error rate, retry count, measured throughput, or latency), a requested session lifetime, and termination conditions, or the like.

Upon receiving the forwarding request from station 302, station 104 may authenticate and validate the request and may determine whether sufficient forwarding capacity exists to serve station 302 while honoring existing commitments (e.g., station 104's own traffic and any other active forwarding sessions). To do so, station 104 may evaluate one or more factors, such as utilization of its upstream path toward AP 102 (either directly over wireless link 108 or via station 106 if a repeater relationship has already been established with station 106), observed or predicted PHY rates, queue depth, available airtime, existing QoS commitments, and the expected forwarding load for station 302 as indicated in the request. If capacity is available, station 104 may transmit an acceptance message (e.g., indicating a granted session lifetime, selected data-plane mode, and applicable QoS parameters) to station 302. Otherwise, station 104 may transmit a negative acknowledgment. In certain embodiments, a stateless relay option may permit station 302 to begin transmitting payloads for opportunistic forwarding for a period of time (e.g., prior to formal acceptance).

In some embodiments, the forwarding request originated by station 302 may also be received by station 106. However, due to the high attenuation of signals transmitted by station 302, station 106 may determine that it cannot reliably receive data directly from station 302. As a result, station 106 may decline to act as a direct repeater for station 302, either by transmitting a negative acknowledgment or by refraining from responding to the forwarding request. This may help ensure that only stations with sufficient link quality and capacity, such as station 104 in this scenario, are selected to forward network traffic on behalf of station 302.

After accepting the forwarding request of station 302, station 104 may initiate or renew a separate forwarding request to station 106 over the control channel 112 (as described above in at least FIG. 1) to establish (if the wireless link 108 has recently entered a deteriorated condition) or scale (if a repeater relationship has already been established between station 104 and station 106) an upstream forwarding session that can accommodate aggregate traffic comprising network traffic from station 302 and station 104. Station 106 may perform admission-control evaluations similar to those described above (e.g., current utilization of link 110, predicted PHY rates, queue depth, airtime availability, and QoS commitments) and may accept or reject based on its capacity and policy constraints. In deployments where station 104 already has an active session with station 106, station 104 may update the session parameters (e.g., expected rate/QoS) to reflect the additional forwarding load attributable to station 302.

In embodiments where a repeater relationship between station 104 and station 106 has already been established, station 104 may query station 106 to determine whether sufficient forwarding capacity exists to accommodate the additional load associated with station 302. In at least some embodiments, acceptance of the forwarding request from station 302 by station 104 is conditional upon confirmation that both station 104 (for the downstream hop from station 302 to station 104) and station 106 (for the upstream hop from station 104 to station 106, and onward to AP 102) have adequate resources under their respective admission-control policies (e.g., available airtime, queue depth, PHY rate margin, and QoS commitments). If station 106 indicates insufficient capacity, station 104 may decline station 302's forwarding request or seek an alternate upstream helper station to forward network traffic from both station 104 and station 302 to AP 102.

During operation, station 104 may schedule and forward uplink traffic originating at station 302 together with station 104's own traffic toward station 106. Station 106, in turn, may schedule and forward uplink traffic originating at station 302 and originating at station 104 toward AP 102 over link 110, while concurrently handling its own network traffic. For downlink traffic, station 106 may receive frames from AP 102 destined for station 104 and/or station 302 and may re-deliver such frames to the appropriate recipient over the established data paths, first between station 106 and station 104 and then between station 104 and station 302. In at least some embodiments, both station 104 and station 106 may maintain per-originator state, which may include forwarding tables, address-resolution context (e.g., ARP), DHCP relay or assignment information (where applicable), and mapping tables used to attribute uplink traffic to the correct originator and to filter or re-deliver downlink frames to the intended station. QoS policies (e.g., per-flow or per-access-category prioritization, airtime fairness, latency/jitter targets, and/or rate limiting) may be applied at each hop to bound the impact of forwarding on the helpers'own traffic and on other forwarded streams. In some cases, participating nodes may coordinate predictable transmission opportunities (e.g., TWT) to improve determinism across the multi-hop path.

In further embodiments, loop-avoidance and path-stability measures may be applied to the daisy-chain configuration. For example, control messages and/or data encapsulations may carry a hopcount or time-to-live parameter and/or path-vector information to prevent routing loops and limit chain length. A policy-configurable maximum hopcount may be used to cap forwarding complexity and airtime consumption.

Teardown of the station 302 to station 104 forwarding session and/or the station 104 to station 106 session may occur upon expiration of a granted lifetime, upon receipt of an explicit terminate message from any participant, upon detection of a failure condition (e.g., loss of VAP association, health-probe failure, or degradation of an inter-station link below thresholds), or upon improvement of a direct link to AP 102. Following teardown, station 302 and/or station 104 may resume direct communication with AP 102 when feasible or may initiate a new discovery and selection process to identify alternate helpers. By enabling controlled multi-hop forwarding within the same BSS under constrained conditions, the system 300 can preserve connectivity and maintain application performance for edge-of-coverage devices without deploying additional fixed infrastructure, such as AP repeaters that enumerate AP 102.

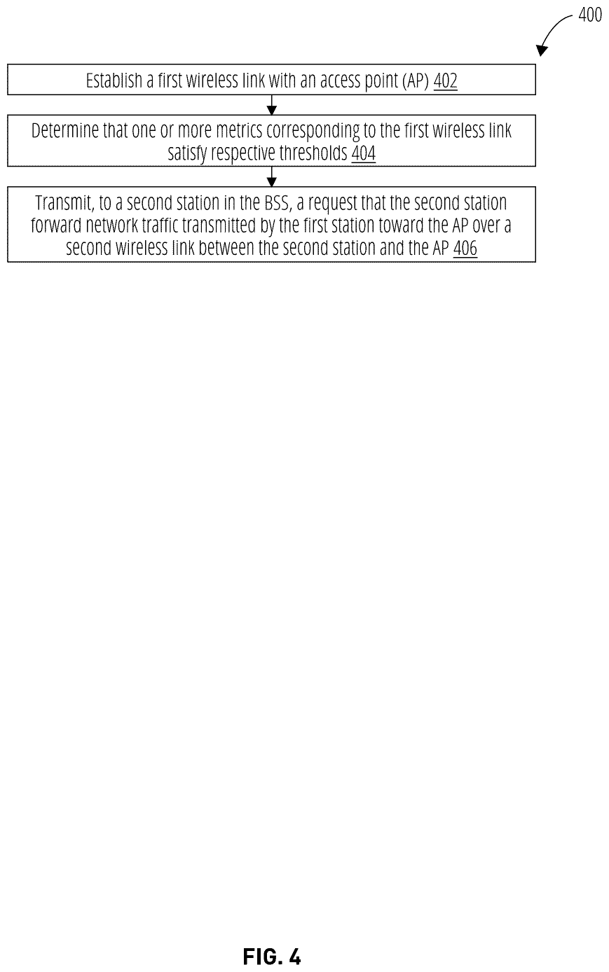

FIG. 4 illustrates a method 400 of establishing a repeater relationship with another station in a same BSS after determining that a wireless link has entered a degraded state or condition, according to one embodiment. According to embodiments, the method 400 may be performed by processing logic that includes hardware, software, firmware, or any combination thereof. In some embodiments, the processing logic includes memory storing instructions where, upon one or more processors executing the instructions, may cause the processing logic to partially or fully perform the method 400. In some embodiments, the method 400 may be performed using one or more devices of the system 100, system 200, or system 300, such as the AP 102, station 104, station 106, station 202, or station 302. Other devices may perform the method 400 as described herein.

At block 402, the processing logic may establish a first wireless link with an access point (AP).

At block 404, the processing logic may determine that one or more metrics corresponding to the first wireless link satisfy respective thresholds. In various embodiments, the one or more metrics may include, but are not limited to, RSSI, SNR, PER, a retry count, a measured throughput, or a latency. The determination may be performed using fixed, adaptive, or policy-driven thresholds, and may be based on real-time monitoring of link quality and performance information.

At block 406, the processing logic may transmit a request that the second station forward network traffic transmitted by the first station toward the AP over a second wireless link between the second station and the AP. The request may be transmitted to a second station in the BSS. In some embodiments, the processing logic may select the second station from multiple candidate stations in the BSS based on one or more of a link quality metric or a current payload, such as the candidate station's available bandwidth, current traffic load, or measured link quality to the AP. The request may be transmitted to the second station in response to selecting the second station.

In certain embodiments, the request may comprise control signaling transmitted out-of-band with respect to the BSS, for example, over an auxiliary wireless channel such as BLE. The request may be transmitted over BLE using a Generic Attribute Profile (GATT) or other suitable BLE protocol, enabling the first station to communicate with the second station even if the first station has lost connectivity to the AP.

Upon transmitting the request, the processing logic may receive, from the second station, a response indicating acceptance of the request. The response may include information such as a granted session lifetime, selected data-plane mode, or applicable QoS parameters. If the response indicates acceptance, the processing logic may transmit network traffic addressed to the AP via the second station by directing network traffic to the second station, which then forwards the traffic toward the AP over its own wireless link.

In some embodiments, the processing logic may periodically re-evaluate the selection of the second station and may migrate the forwarding relationship to another candidate station if performance degrades or if a better candidate becomes available. The method may further include teardown procedures, such as terminating the forwarding relationship upon expiration of a granted lifetime, receipt of a termination message, or detection of improved link conditions.

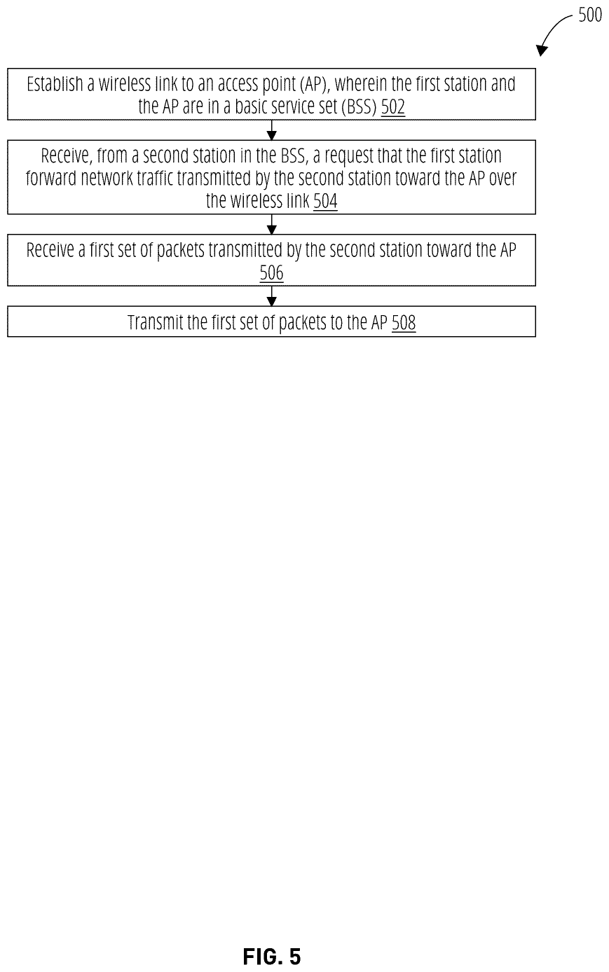

FIG. 5 illustrates a method 500 of establishing a repeater relationship with another station in a same BSS after receiving a request, according to one embodiment. According to embodiments, the method 500 may be performed by processing logic that includes hardware, software, firmware, or any combination thereof. In some embodiments, the processing logic includes memory storing instructions where, upon one or more processors executing the instructions, may cause the processing logic to partially or fully perform the method 500. In some embodiments, the method 500 may be performed using one or more devices of the system 100, system 200, or system 300, such as the AP 102, station 104, station 106, station 202, or station 302. Other devices may perform the method 500 as described herein.

At block 502, the processing logic may establish a wireless link to an access point (AP) for a first station, wherein the first station and the AP are in a basic service set (BSS). In some embodiments, after establishing the wireless link, the processing logic may monitor one or more metrics corresponding to the first wireless link on an ongoing basis (e.g., RSSI, SNR, PER, retry count, measured throughput, or latency) using fixed, adaptive, or policy-driven thresholds to inform subsequent admission and acceptance decisions.

At block 504, the processing logic may receive, from a second station in the BSS, a request that the first station forward network traffic transmitted by the second station toward the AP over the wireless link. In certain embodiments, the request may comprise control signaling received OOB with respect to the BSS, for example over BLE (e.g., a GATT-based message), or may be received in-band via AP-relayed action/management frames or TDLS. In response to receiving the request, the processing logic may determine that one or more metrics corresponding to the first wireless link satisfy respective thresholds and/or determine that sufficient forwarding capacity is available on the wireless link based on at least one of (i) current utilization of the wireless link or (ii) an expected forwarding traffic rate for the second station. When the applicable criteria are satisfied, the processing logic may transmit, to the second station, a response indicating acceptance of the request, which can include a granted session lifetime, selected data-plane mode, and applicable QoS parameters.

At block 506, the processing logic may receive a first set of packets transmitted by the second station toward the AP. In some embodiments, the first station may maintain a VAP interface for the second station, and the first set of packets may be received via the VAP association. In other embodiments, the packets may be received via bridging, WDS/four-address forwarding, or other suitable data-plane mechanisms.

At block 508, the processing logic may transmit the first set of packets to the AP. The processing logic may also transmit a second set of packets originating at the first station to the AP, and may schedule transmission of the first set of packets and the second set of packets according to one or more QoS policies, such as per-flow or per-access-category prioritization, airtime fairness, latency/jitter targets, minimum/maximum rate guarantees, and/or rate limiting.

In various embodiments, the processing logic may periodically re-evaluate link-quality metrics and forwarding capacity during the session and continue, adjust, or terminate forwarding based on policy. Teardown may occur upon expiration of a granted lifetime, receipt of a termination message, detection of a failure condition, or improvement of the second station's direct AP link.

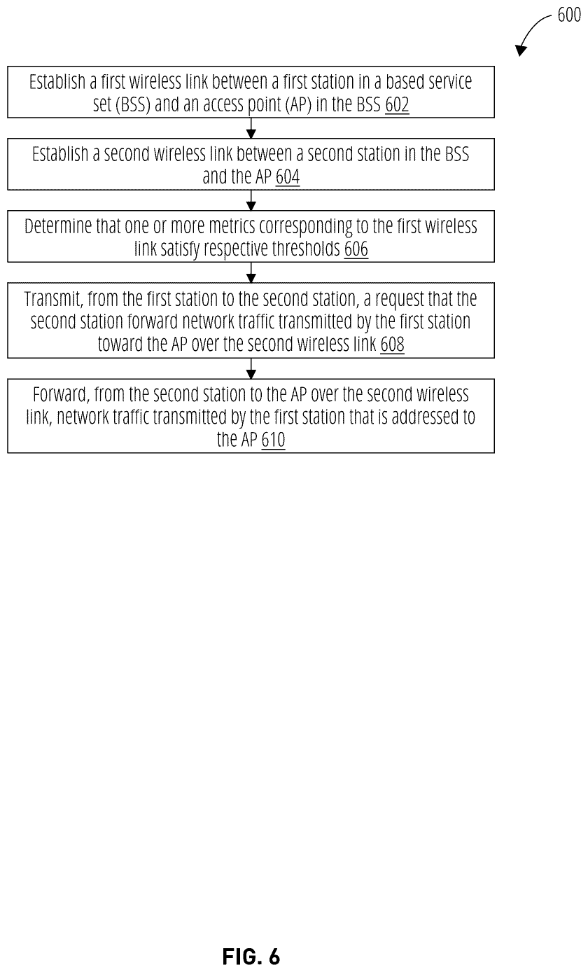

FIG. 6 illustrates a method 600 of two stations establishing a repeater relationship after determining that a wireless link has entered a degraded state or condition, according to one embodiment. According to embodiments, the method 600 may be performed by processing logic that includes hardware, software, firmware, or any combination thereof. In some embodiments, the processing logic includes memory storing instructions where, upon one or more processors executing the instructions, may cause the processing logic to partially or fully perform the method 600. In some embodiments, the method 600 may be performed using one or more devices of the system 100, system 200, or system 300, such as the AP 102, station 104, station 106, station 202, or station 302. Other devices may perform the method 600 as described herein.

At block 602, the processing logic may establish a first wireless link between a first station in a basic service set (BSS) and an access point (AP) in the BSS.

At block 604, the processing logic may establish a second wireless link between a second station in the BSS and the AP.

At block 606, the processing logic may determine that one or more metrics corresponding to the first wireless link satisfy respective thresholds. In various embodiments, the one or more metrics may include, but are not limited to, RSSI, SNR, PER, retry count, measured throughput, or latency. The determination may be performed using fixed, adaptive, or policy-driven thresholds.

At block 608, the processing logic may transmit, from the first station to the second station, a request that the second station forward network traffic transmitted by the first station toward the AP over the second wireless link. In some embodiments, the request may comprise control signaling transmitted OOB with respect to the BSS, for example, over BLE, or may be transmitted in-band via AP-relayed management frames or TDLS.

At block 610, the processing logic may forward, from the second station to the AP over the second wireless link, network traffic transmitted by the first station that is addressed to the AP.

In certain embodiments, the second station may determine that one or more metrics corresponding to the second wireless link satisfy respective thresholds before accepting the forwarding request. These metrics may include RSSI, SNR, PER, retry count, measured throughput, or latency, and may be evaluated using fixed, adaptive, or policy-driven thresholds.

Additionally, the second station may determine that sufficient forwarding capacity is available on the second wireless link based on at least one of (i) current utilization of the second wireless link or (ii) an expected forwarding traffic rate for the first station. If the applicable criteria are satisfied, the second station may transmit, to the first station, a response indicating acceptance of the request, which may include a granted session lifetime, selected data-plane mode, and applicable QoS parameters.

In some implementations, the second station may periodically re-evaluate link-quality metrics and forwarding capacity during the session and continue, adjust, or terminate forwarding based on policy. Teardown may occur upon expiration of a granted lifetime, receipt of a termination message, detection of a failure condition, or improvement of the first station's direct AP link.

In the above description, numerous details are set forth. It will be apparent, however, to one of ordinary skill in the art having the benefit of this disclosure that embodiments of the present disclosure may be practiced without these specific details. In some instances, well-known structures and devices are shown in block diagram form, rather than in detail, in order to avoid obscuring the description. Additionally, in the above description, reference is made to the accompanying figures which form a part hereof, and in which is shown, by way of illustration, several embodiments of the present disclosure. It is understood that other embodiments may be utilized, and structural changes may be made without departing from the scope of the present disclosure.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example” or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “some embodiments” throughout is not intended to mean the same embodiment or embodiments unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, and any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid unnecessarily obscuring the present disclosure. Thus, the specific details set forth above are merely exemplary. Particular embodiments may vary from these exemplary details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, for purposes of explanation, numerous specific details are set forth in order to provide a thorough understanding of the present disclosure. It will be evident, however, to one skilled in the art that the present disclosure may be practiced without these specific details. In other instances, well-known circuits, structures, and techniques are not shown in detail, but rather in a block diagram in order to avoid unnecessarily obscuring an understanding of this description.

Reference in the description to “one embodiment,” “an embodiment,” “some embodiments,” “various embodiments,” “according to embodiments,” or the like means that a particular feature, structure, or characteristic described in connection with the embodiment(s) is included in at least one embodiment of the disclosure. The phrase “in one embodiment” or “in some embodiments” located in various places in this description does not necessarily refer to the same embodiment(s).

What is claimed is:

1. A method of operating a first station in a basic service set (BSS), the method comprising:
establishing a first wireless link with an access point (AP);
determining that one or more metrics corresponding to the first wireless link satisfy respective thresholds; and
transmitting, to a second station in the BSS, a request that the second station forward network traffic transmitted by the first station toward the AP over a second wireless link between the second station and the AP.

2. The method of claim 1, further comprising:
receiving, from the second station, a response indicating acceptance of the request.

3. The method of claim 2, further comprising:
transmitting network traffic addressed to the AP via the second station by directing network traffic to the second station.

4. The method of claim 1, wherein the one or more metrics comprise at least one of a received signal strength indicator (RSSI), a signal-to-noise ratio (SNR), a packet error rate (PER), a retry count, a measured throughput, or a latency.

5. The method of claim 1, further comprising:
selecting the second station from multiple candidate stations in the BSS based on one or more of a link quality metric or a current traffic load.

6. The method of claim 5, wherein the request is transmitted to the second station in response to selecting the second station.

7. The method of claim 1, wherein the request comprises control signaling transmitted out-of-band with respect to the BSS.

8. The method of claim 7, wherein the request is transmitted over Bluetooth Low Energy (BLE).

9. A first station of a basic service set (BSS), the first station to:
establish a wireless link to an access point (AP), wherein the first station and the AP are in a basic service set (BSS);
receive, from a second station in the BSS, a request that the first station forward network traffic transmitted by the second station toward the AP over the wireless link;
receive a first set of packets transmitted by the second station toward the AP; and
transmit the first set of packets to the AP.

10. The first station of claim 9, wherein the first station is further to:
transmit a second set of packets originating at the first station to the AP.

11. The first station of claim 10, wherein the instructions further cause the first station to:
schedule transmission of the first set of packets and the second set of packets according to one or more quality-of-service (QoS) policies.

12. The first station of claim 9, wherein the first station is further to:
maintain a virtual access point (VAP) interface for the second station.

13. The first station of claim 9, wherein the first station is further to:
determine that one or more metrics corresponding to the first wireless link satisfy respective thresholds; and
transmit, to the second station, a response indicating acceptance of the request.

14. The first station of claim 13, wherein the one or more metrics comprise at least one of a received signal strength indicator (RSSI), a signal-to-noise ratio (SNR), a packet error rate (PER), a retry count, a measured throughput, or a latency.

15. The first station of claim 9, wherein the first station is further to
determine that sufficient forwarding capacity is available on the wireless link based on at least one of (i) current utilization of the wireless link or (ii) an expected forwarding traffic rate for the second station; and
transmit, to the second station, a response indicating acceptance of the request.

16. The first station of claim 9, wherein the request comprises control signaling received out-of-band with respect to the BSS.

17. A system comprising:
an access point (AP) in a basic service set (BSS);
a first station in the BSS; and
a second station in the BSS, wherein the system is to:
establish a first wireless link between the first station and the AP and a second wireless link between the second station and the AP;
determine that one or more metrics corresponding to the first wireless link satisfy respective thresholds;
transmit, from the first station to the second station, a request that the second station forward network traffic transmitted by the first station toward the AP over the second wireless link; and
forward, from the second station to the AP over the second wireless link, network traffic transmitted by the first station that is addressed to the AP.

18. The system of claim 17, wherein the system is further to:
determine, by the second station, that one or more metrics corresponding to the second wireless link satisfy respective thresholds; and
transmit, from the second station to the first station, a response indicating acceptance of the request.

19. The system of claim 17, wherein the system is further to:
determine that sufficient forwarding capacity is available on the second wireless link based on at least one of (i) current utilization of the second wireless link or (ii) an expected forwarding traffic rate for the first station; and
transmit, from the second station to the first station, a response indicating acceptance of the request.

20. The system of claim 17, wherein the request comprises control signaling transmitted out-of-band with respect to the BSS.
